(19) United States
(12) Patent Application Publication
(10) Pub. No.: US 2020/0092489 A1
(43) Pub. Date: Mar. 19, 2020

(54) OPTICAL APPARATUS, CONTROL METHOD, AND NON-TRANSITORY COMPUTER-READABLE STORAGE MEDIUM

(71) Applicant: CANON KABUSHIKI KAISHA, Tokyo (JP)

(72) Inventor: Yu Inagaki, Tokyo (JP)

(21) Appl. No.: 16/565,948

(22) Filed: Sep. 10, 2019

(30) Foreign Application Priority Data
Sep. 14, 2018 (JP) 2018-172935

(51) Int. Cl. H04N 5/232; H04N 5/225; G02B 7/10; G03B 17/14

(52) U.S. Cl. CPC H04N 5/232122; H04N 5/2254; G02B 5/201; G03B 17/14; G02B 7/102

(57) ABSTRACT

An optical apparatus is an image-capturing apparatus to which an image-capturing optical system is interchangeably attached. The optical apparatus comprises an image sensor 122 configured to capture an object image formed via the image-capturing optical system, a focus detector 129 configured to perform focus detection by a phase difference detection method using the image sensor and a controller 125 having a processor which executes instructions stored in a memory or having circuitry, the controller being configured to calculate a drive amount of a focus element using a defocus amount acquired by the focus detection and a focus sensitivity of the image-capturing optical system. The controller acquires correction data unique to the attached image-capturing optical system and corresponding to a blue spread amount on the image sensor, and calculates the drive amount using the focus sensitivity corrected by using the correction data.

### BACKGROUND OF THE INVENTION

### Field of the Invention

The present invention relates to focus control by an image-capturing surface phase difference detection method.

### Description of the Related Art

In focus control (phase difference AF) using a phase difference detection method, a drive amount of a focus lens (hereinafter referred to as focus drive amount) is determined using a detected defocus amount of an image-capturing optical system and a focus sensitivity. The focus sensitivity indicates a ratio between a unit movement amount of the focus lens and a displacement amount of an image position in an optical axis direction. The focus drive amount for obtaining an in-focus state can be obtained by dividing the detected defocus amount by the focus sensitivity.

Japanese Patent Application Laid-Open No. 2017-40732 discloses an image-capturing apparatus that corrects a focus sensitivity according to an image height for detecting a defocus amount.

In the image-capturing surface phase difference AF which is a phase difference AF using an image sensor, the defocus amount is calculated by detecting a spread amount of an image blur in an in-plane direction of the image sensor (image-capturing surface), and the focus drive amount is obtained by dividing this defocus amount by the focus sensitivity.

However, in a case where the image-capturing optical system has different aberrations due to individual differences, even if the spread amount of the image blur is the same, high-precision AF results (in-focus state) cannot be obtained with the same focus drive amount.

### SUMMARY OF THE INVENTION

The present invention provides an image-capturing apparatus capable of obtaining high-precision AF results for image-capturing optical systems having different aberrations.

An optical apparatus an one aspect of the present invention is as an image-capturing apparatus to which an image-capturing optical system is interchangeably attached, the optical apparatus comprising: an image sensor configured to capture an object image formed via the image-capturing optical system; a focus detector configured to perform focus detection by a phase difference detection method using the image sensor; and a controller having a processor which executes instructions stored in a memory or having circuitry, the controller being configured to calculate a drive amount of a focus element using a defocus amount acquired by the focus detection and a focus sensitivity of the image-capturing optical system, wherein the controller acquires correction data unique to the attached image-capturing optical system and corresponding to a blue spread amount on the image sensor, and calculates the drive amount using the focus sensitivity corrected by using the correction data.

An optical apparatus as another aspect of the present invention is an interchangeable lens apparatus which is interchangeably attached to an image-capturing apparatus which performs focus detection by a phase difference detection method using an image sensor configured to capture an object image formed by an image-capturing optical system, the optical apparatus comprising: the image-capturing optical system; and a controller having a processor which executes instructions stored in a memory or having circuitry, the controller being configured to transmit, to the image-capturing apparatus, information for causing the image-capturing apparatus to acquire correction data unique to the image-capturing optical system for correcting a focus sensitivity of the image-capturing optical system and corresponding to a blur-spread amount on the image sensor.

An optical apparatus as another aspect of the present invention is an interchangeable lens apparatus which is interchangeably attached to an image-capturing apparatus which performs focus detection by a phase difference detection method using an image sensor configured to capture an object image formed via an image-capturing optical system, the image-capturing apparatus configured to calculate a drive amount of a focus element using a defocus amount acquired by the focus detection and a focus sensitivity of the image-capturing optical system, the optical apparatus comprising: the image-capturing optical system; and a controller having a processor which executes instructions stored in a memory or having circuitry, the controller being configured to acquire correction data unique to the image-capturing optical system for correcting the focus sensitivity and corresponding to a blur-spread amount on the image sensor, and transmit the correction data to the image-capturing apparatus.

A control method as another aspect of the present invention is a control method for an optical apparatus as an image-capturing apparatus to which an image-capturing optical system is interchangeably attached and which has an image sensor configured to capture an object image formed via the image-capturing optical system, the control method comprising: a step of performing focus detection by a phase difference detection method using the image sensor; and a step of calculating a drive amount of a focus element using a defocus amount acquired by the focus detection and a focus sensitivity of the image-capturing optical system, wherein the step of calculating the drive amount acquires correction data unique to the attached image-capturing optical system and corresponding to a blur-spread amount on the image sensor, and calculates the drive amount using the focus sensitivity corrected by using the correction data.

A control method as another aspect of the present invention is a control method for an optical apparatus as an interchangeable lens apparatus which is interchangeably attached to an image-capturing apparatus which performs focus control by a phase difference detection method using an image sensor configured to capture an object image formed via an image-capturing optical system, the control method comprising: a step of transmitting, to the image-capturing apparatus, information for causing the image-capturing apparatus to acquire correction data unique to the image-capturing optical system for correcting a focus sensitivity of the image-capturing optical system and corresponding to a blur-spread amount on the image sensor.

A control method as another aspect of the present invention is a control method for an optical apparatus as an interchangeable lens apparatus which is interchangeably attached to an image-capturing apparatus which performs focus control by a phase difference detection method using an image sensor configured to capture an object image formed via an image-capturing optical system, the image-capturing apparatus configured to calculate a drive amount of a focus element using a defocus amount acquired by the focus detection and a focus sensitivity of the image-capturing optical system, the control method comprising: a step of acquiring correction data unique to the image-capturing optical system for correcting the focus sensitivity and corresponding to a blur-spread amount on the image sensor; and a step of transmitting the correction data to the image-capturing apparatus.

A computer program which causes a computer of an optical apparatus to execute processing according to the above control methods is also another aspect of the present invention.

Further features of the present invention will become apparent from the following description of exemplary embodiments with reference to the attached drawings.

### BRIEF DESCRIPTION OF THE DRAWINGS

FIG. 1 is a block diagram showing a configuration of an image-capturing apparatus as the first embodiment 1 of the present invention.

FIGS. 2A and 2B are diagrams showing a configuration of a pixel array and a readout circuit of an image sensor in the image-capturing apparatus of the first embodiment.

FIGS. 3A and 3B are diagrams for explaining focus detection by a phase difference detection method in the first embodiment.

FIGS. 4A and 4B is another diagram for explaining the above-mentioned focus detection.

FIGS. 5A and 5B are diagrams for explaining correlation calculation in the first embodiment.

FIG. 6 is a flowchart showing AF processing in the first embodiment.

FIG. 7 is a diagram for explaining a focus sensitivity and a spread amount of a blur on an image sensor in a state without an aberration in the first embodiment.

FIG. 8 is a diagram for explaining the focus sensitivity and the spread amount in a state with an aberration in the first embodiment.

FIG. 9 is a diagram for explaining a relationship between an imaging position and a blur-spread amount in the first embodiment.

FIG. 10 is a diagram for explaining a point image intensity distribution in a defocus state according to the first embodiment.

FIG. 11 is a diagram for explaining a relationship between an imaging position and correction data in the first embodiment.

FIG. 12 is a flowchart showing calculation processing of a focus drive amount in the first embodiment.

FIG. 13 is a flowchart showing calculation processing of a focus drive amount according to the second embodiment of the present invention.

FIG. 14 is a diagram for explaining a relationship between an imaging position and MTF (8 lines/mm) in the third embodiment of the present invention.

FIG. 15 is a diagram for explaining a relationship between an imaging position and MTF (2 lines/mm) in the third embodiment.

FIG. 16 is a flowchart showing calculation processing of a focus drive amount in the third embodiment.

FIG. 17 is a diagram showing a relationship between an image shift amount X and a blur-spread amount x.

### DESCRIPTION OF THE EMBODIMENTS

Hereinafter, embodiments of the present invention will be described with reference to the drawings.

### First Embodiment

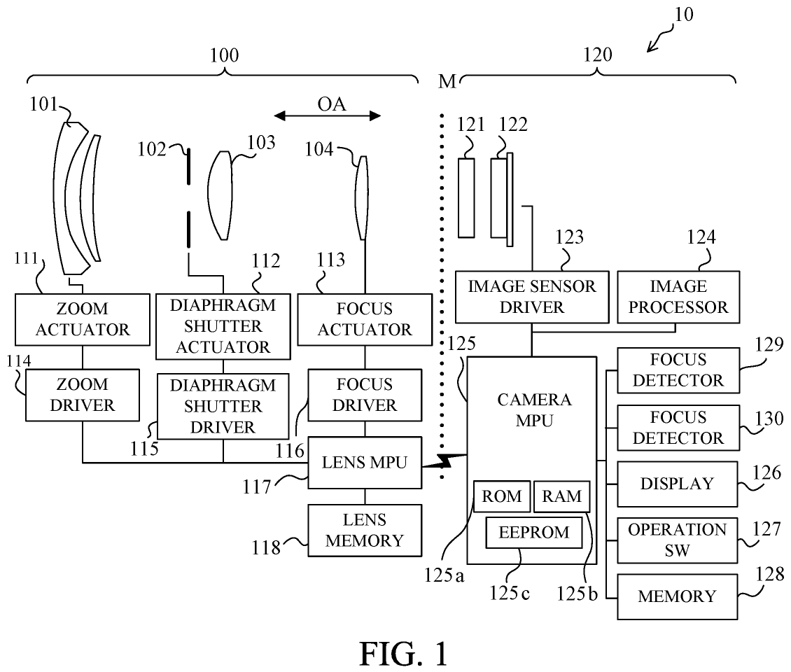

FIG. 1 shows a configuration of a lens-interchangeable digital camera (image-capturing apparatus: hereinafter referred to as a camera body) 120 as an optical apparatus and a lens unit (interchangeable lens apparatus) 100 as an optical apparatus, which is the first embodiment 1 of the present invention. The lens unit 100 is detachably attachable (interchangeable) to the camera body 120. A camera system 10 is configured by the camera body 120 and the lens unit 100.

The lens unit 100 is attached to the camera body 120 via a mount M shown by a dotted line in a center of the figure. The lens unit 100 includes an image-capturing optical system including, in order from an object side (left side in the figure), a first lens 101, a diaphragm 102, a second lens 103, and a focus lens (focus element) 104. Each of the first lens 101, the second lens 103, and the focus lens 104 is configured of one or more lenses. The lens unit 100 also has a lens drive/control system that drives and controls the image-capturing optical system.

The first lens 101 and the second lens 103 move in the optical axis direction OA, which is a direction in which the optical axis of the image-capturing optical system extends, for zooming. The diaphragm 102 has a function to adjust a light amount and a function as a mechanical shutter to control an exposure time at the time of still-image capturing. The diaphragm 102 and the second lens 103 move integrally in the optical axis direction OA in zooming. The focus lens 104 moves in the optical axis direction OA to change an object distance (in-focus distance) in which the image-capturing optical system is in-focus, that is, performs focus adjustment.

The lens drive/control system includes a zoom actuator 111, a diaphragm shutter actuator 112, a focus actuator 113, a zoom driver 114, a diaphragm shutter driver 115, a focus driver 116, a lens MPU 117, and a lens memory 118. The zoom driver 114 drives the zoom actuator 111 to move the first lens 101 and the second lens 103 in the optical axis direction OA. The diaphragm shutter driver 115 drives the diaphragm shutter actuator 112 to operate the diaphragm 102, and controls an aperture diameter of the diaphragm 102 and a shutter opening/closing operation. The focus driver 116 drives the focus actuator 113 to move the focus lens 104 in the optical axis direction OA. The focus driver 116 detects a position of the focus lens 104 using a sensor (not shown) provided on the focus actuator 113.

The lens MPU 117 can communicate data and commands with a camera MPU 125 provided in a camera body 120 via a communication contact (not shown) provided in the mount M. The lens MPU 117 transmits lens position information to the camera MPU 125 in response to a request command from the camera MPU 125. The lens position information includes information on a position of the focus lens 104 in the optical axis direction OA, information on a position and diameter of an exit pupil of the image-capturing optical system in the optical axis direction OA in an undriven state, and information on a position and diameter of a lens frame, in the optical axis direction, that limits a light flux passing through the exit pupil. The lens MPU 117 controls the zoom driver 114, the diaphragm shutter driver 115, and the focus driver 116 in accordance with a control command from the camera MPU 125. As a result, zoom control, aperture/shutter control and focus adjustment (AF) control are performed.

A lens memory (storage unit) 118 stores in advance optical information necessary for the AF control. The camera MPU 125 controls an operation of the lens unit 100 by executing a program stored in a built-in non-volatile memory or the lens memory 118.

The camera body 120 has a camera optical system including an optical low pass filter 121 and an image sensor 122, and a camera drive/control system.

The optical low pass filter 121 reduces false color and moire of a captured image. The image sensor 122 includes a CMOS image sensor and its periphery, and photoelectrically converts (captures) an object image formed by the image-capturing optical system. The image sensor 122 has a plurality of m pixels in a horizontal direction and a plurality of n pixels in a vertical direction. In addition, the image sensor 122 has a pupil division function described later. The image sensor 122 can perform AF (image-capturing surface phase difference AF: hereinafter, also simply referred to as phase difference AF) in a phase difference detection method using a phase difference image signal, which will be described later, generated from an output of the image sensor 122.

The camera drive/control system includes an image sensor driver 123, an image processor 124, the camera MPU 125, a display 126, an operation switch group 127, a phase difference focus detector 129, and a TVAF focus detector 130. The image sensor driver 123 controls a driving of the image sensor 122. The image processor 124 converts an analog image-capturing signal which is an output from the image sensor 122 into a digital image-capturing signal, performs y conversion, white balance processing and color interpolation processing on the digital image-capturing signal, and generate a video signal (image data) to output to the camera MPU 125. The camera MPU 125 causes the display 126 to display the image data, and causes a memory 128 to record the image data as captured image data. In addition, the image processor 124 performs compression encoding processing on the image data as needed. Further, the image processor 124 generates, from the digital imaging signal, a pair of phase difference image signals and TVAF image data (RAW image data) used in the TVAF focus detector 130.

The camera MPU 125 as a camera controller performs calculations and control necessary for the entire camera system. The camera MPU 125 transmits, to the lens MPU 117 as a lens controller, the above-described lens position information, a request command for optical information unique to the lens unit 100, and a control command for zoom adjustment, aperture adjustment, and focus adjustment. The camera MPU 125 incorporates a ROM 125a storing a program for performing the above calculation and control, a RAM 125b storing variables, and an EEPROM 125c storing various parameters.

The display 126 is configured by an LCD or the like, and displays the image data described above, an image-capturing mode, and other information related to image-capturing. The image data includes preview image data before image-capturing, image data for focus confirmation at the time of AF, image data for image-capturing confirmation after image-capturing recording, and the like. The operation switch group 127 includes a power switch, a release (image-capturing trigger) switch, a zoom operation switch, an image-capturing mode selection switch, and the like. The memory 128 is a flash memory that is detachably attachable to the camera body 120, and records captured image data.

The phase difference focus detector 129 performs focus detection processing in the phase difference AF using the phase difference image signal obtained from the image processor 124. A light flux from the object passes through a pair of pupil regions divided by the pupil division function of the image sensor 122 in the exit pupil of the image-capturing optical system, and a pair of phase difference images (optical images) are formed on the image sensor 122. The image sensor 122 outputs a signal obtained by photoelectrically converting these pair of phase difference images to the image processor 124. The image processor 124 generates a pair of phase difference image signals from this signal, and outputs the pair of phase difference image signals to the phase difference focus detector 129 via the camera MPU 125. The phase difference focus detector 129 performs a correlation operation on the pair of phase difference image signals to obtain a shift amount between the pair of phase difference image signals (phase difference: hereinafter, referred to as an image shift amount) and output the image shift amount to the camera MPU 125. The camera MPU 125 calculates a defocus amount of the image-capturing optical system from the image shift amount.

The phase difference AF performed by the phase difference focus detector 129 and the camera MPU 125 will be described in detail later. The phase difference focus detector 129 and the camera MPU 125 constitute a focus detection apparatus.

The TVAF focus detection unit 130 generates a focus evaluation value (contrast evaluation value) indicating the contrast state of the image data from the TVAF image data input from the image processing unit 124. The camera MPU 125 moves the focus lens 104 to search for a position at which the focus evaluation value reaches a peak, and detects the position as a TVAF focus position. TVAF is also referred to as contrast detection AF (contrast AF).

Thus, the camera body 120 of this embodiment can perform both phase difference AF and TVAF (contrast AF), and these can be used selectively or in combination.

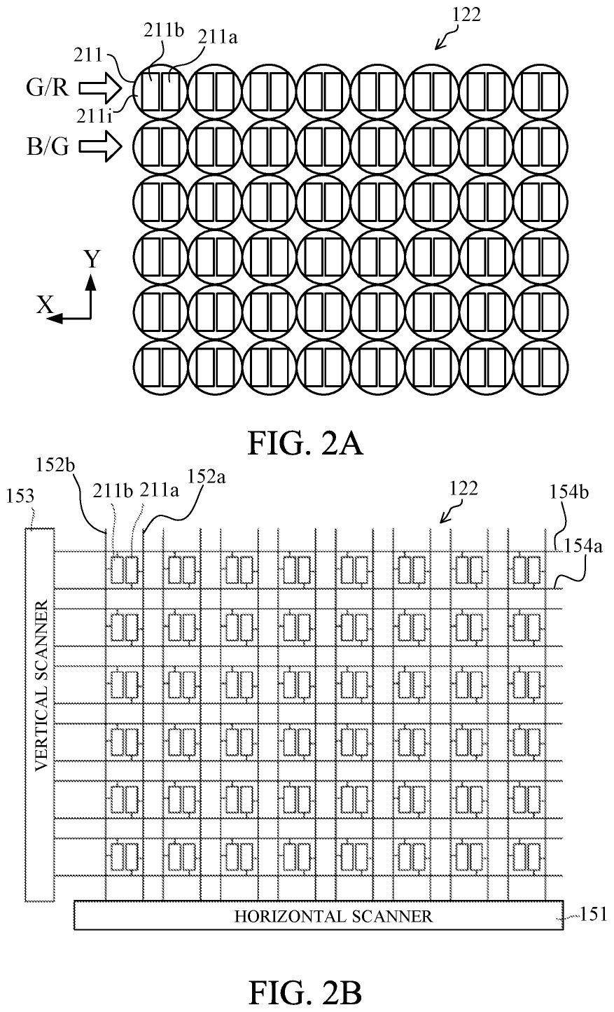

Next, an operation of the phase difference focus detector 129 will be described. FIG. 2A shows a pixel array of the image sensor 122, and shows a range of vertical (Y direction) six pixel rows and horizontal (X direction) eight pixel columns of the CMOS image sensor, viewed from the lens unit 100 side. The image sensor 122 is provided with a Bayer-arranged color filter, and green (G) and red (R) color filters are alternately arranged in order from the left in the pixels in the odd rows, and blue (B) and green (G) color filters are alternately arranged in order from the left in the pixels in the even rows. In the pixel 211, a circle denoted by reference numeral 211i indicates an on-chip microlens (hereinafter simply referred to as a microlens), and two rectangles denoted by reference numerals 211a and 211b disposed inside the microlens 211i indicate photoelectric convertors, respectively.

In the image sensor 122, photoelectric convertors in all pixels are divided into two in the X direction. The image sensor 122 can read out a photoelectric conversion signal from each photoelectric convertor and a signal obtained by adding (combining) two photoelectric conversion signals from the two photoelectric convertors of the same pixel (hereinafter referred to as an addition photoelectric conversion signal). By subtracting the photoelectric conversion signal output from one photoelectric convertor from the addition photoelectric conversion signal, a signal corresponding to the photoelectric conversion signal output from the other photoelectric convertor can be obtained. The photoelectric conversion signals from the individual photoelectric convertors are used to generate the phase difference image signals, and are used to generate parallax images that constitute a 3D image. The addition photoelectric conversion signal is used to generate normal display image data, captured image data, and further, TVAF image data.

The pair of phase difference image signals used for the phase difference AF will be described. The image sensor 122 divides the exit pupil of the image-capturing optical system by the micro lens 211i and the divided photoelectric convertors 211a and 211b shown in FIG. 2A. A signal obtained by combining the photoelectric conversion signals from the photoelectric convertors 211a of the plurality of pixels 211 in a predetermined region arranged in the same pixel row is an A image signal which is one of the pair of phase difference image signals. A signal obtained by combining the photoelectric conversion signals from the photoelectric convertors 211b of the plurality of pixels 211 is a B image signal which is the other of the pair of phase difference image signals. When the photoelectric conversion signal from the photoelectric convertor 211a and the addition photoelectric conversion signal are read out from each pixel, the signal corresponding to the photoelectric conversion signal from the photoelectric convertor 211b is obtained by subtracting the photoelectric conversion signal output from the photoelectric convertor 211a from the addition photoelectric conversion signal. The A image signal and the B image signal are pseudo luminance (Y) signals generated by adding the photoelectric conversion signals from pixels provided with red, blue and green color filters. However, the A and B image signals may be generated for each of red, blue and green colors.

By calculating a relative image shift amount of the A image signal and the B image signal generated in this way by correlation calculation, it is possible to obtain the defocus amount in the predetermined region.

FIG. 2B shows a circuit configuration of a readout unit of the image sensor 122. Horizontal scanning lines 152a and 152b and vertical scanning lines 154a and 154b are provided at a boundary of each pixel (photoelectric convertors 211a and 211b) leading to a horizontal scanner 151 and a vertical scanner 153. A signal from each photoelectric convertor is read out via these scan lines.

The camera body 120 of this embodiment has a first readout mode and a second readout mode as readout modes of signals from the image sensor 122. The first readout mode is an all-pixel readout mode, which is a mode for capturing a high definition still image. In the first readout mode, signals are read out from all the pixels of the image sensor 122. The second readout mode is a decimating readout mode and is a mode for performing only moving image recording or preview image display. Since the number of pixels required for the second readout mode is smaller than the total number of pixels, only the photoelectric conversion signals from the pixels decimated at a predetermined ratio in the X direction and the Y direction are read out.

The second readout mode is also used when it is necessary to read out the image sensor 122 at a high speed. When decimating the pixels from which signals are read out in the X direction, the signals are added to improve an S/N ratio, and when decimating in the Y direction, signals from the decimated pixel rows are ignored. The phase differences AF and TVAF are performed using the photoelectric conversion signals read out in the second read mode.

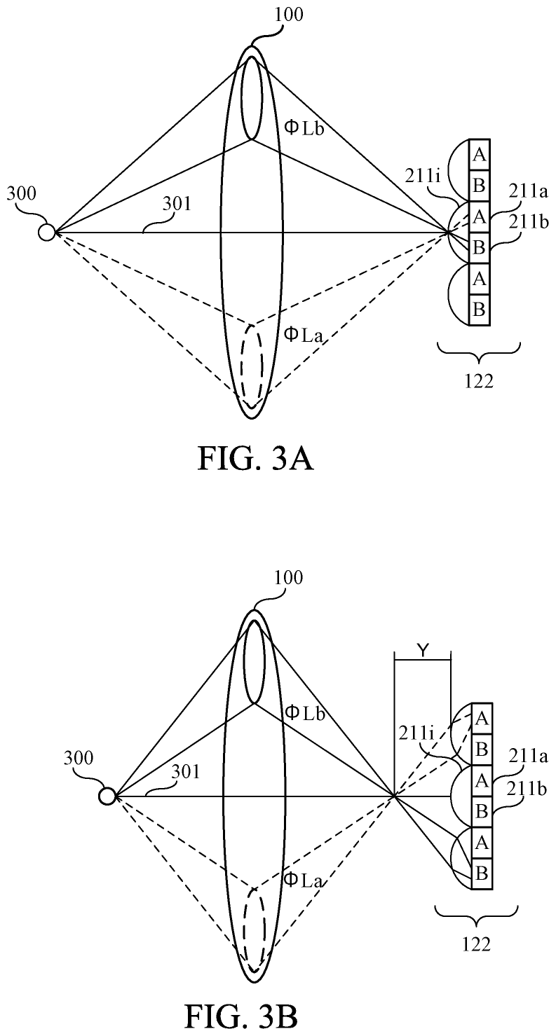

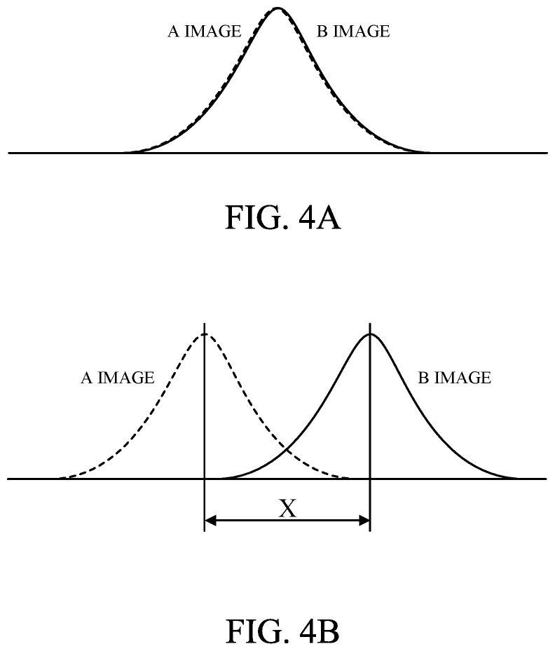

Next, focus detection by the phase difference detection method will be described with reference to FIGS. 3A and 3B and FIG. 4. FIGS. 3A and 3B show a relationship between a focus and a phase difference in the image sensor 122. FIG. 3A illustrates a positional relationship of the lens unit (image-capturing optical system) 100, the object 300, the optical axis 301, and the image sensor 122 in an in-focus state in which the focus (focus position) is in-focus, together with light flux. FIG. 3B shows the above-mentioned positional relationship in an out-of-focus state, together with light flux.

FIGS. 3A and 3B show a pixel array when the image sensor 122 shown in FIG. 2A is cut along a plane including the optical axis 301. One microlens 211i is provided in each pixel of the image sensor 122. As described above, the photodiodes 211a and 211b receive the light flux that has passed through the same microlens 211i. Due to the pupil division action of the microlens 211i and the photodiodes 211a and 211b, two optical images (hereinafter referred to as two images) having a phase difference with each other are formed on the photodiodes 211a and 211b. In the following description, the photodiode 211a is also referred to as a first photoelectric convertor, and the photodiode 211b is also referred to as a second photoelectric convertor. In FIGS. 3A and 3B, the first photoelectric convertor is indicated by A, and the second photoelectric convertor is indicated by B.

On an image-capturing surface of the image sensor 122, pixels having one microlens 211i and the first and second photoelectric convertors are two-dimensionally arranged. Four or more photodiodes (two each in the vertical direction and the horizontal direction) may be arranged for one microlens 211i. That is, any configuration may be employed as long as a plurality of photoelectric convertors are provided for one microlens 211i.

In FIGS. 3A and 3B, the lens unit 100 including the first lens 101, the second lens 103, and the focus lens 104 is shown as one lens. The light flux emitted from the object 300 passes through the exit pupil of the lens unit 100 and reaches the image sensor 122 (image-capturing surface). Under this circumstance, the first and second photoelectric convertors provided in each pixel on the image sensor 122 receive light fluxes from two mutually different pupil regions in the exit pupil via the microlens 211i, respectively. That is, the first and second photoelectric convertors divide the exit pupil of the lens unit 100 into two.

A light flux from a specific point on the object 300 is divided into a light flux ΦLa that passes through a pupil region (indicated by a broken line) corresponding to the first photoelectric convertor and enters the first photoelectric convertor, and a light flux ΦLb that passes through a pupil region (indicated by a solid line) corresponding to the second photoelectric convertor and enters the second photoelectric convertor. Since these two light fluxes are light fluxes from the same point on the object 300, they pass through one microlens 211i and reach one point on the image sensor 122 in the in-focus state as shown in FIG. 3A. Therefore, the A and B image signals generated by combining together the photoelectric conversion signals obtained from the first and second photoelectric convertors that received the two light fluxes that have passed through the microlens 211i in the plurality of pixels coincide with each other.

On the other hand, as shown in FIG. 3B, in the out-of-focus state in which focus is shifted by Y in the optical axis direction, arrival positions of the light fluxes ΦLa and ΦLb on the image sensor 122 are shifted from each other in a direction orthogonal to the optical axis 301 by a change of an incident angle of the light fluxes ΦLa and ΦLb to the microlens 211i. Therefore, the A image signal and the B image signal generated by combining together the photoelectric conversion signals obtained from the first and second photoelectric convertors that received the two light fluxes that have passed through the microlens 211i in the plurality of pixels have a phase difference with each other.

As described above, the image sensor 122 of this embodiment can perform independent reading in which the photoelectric conversion signal is read out from the first photoelectric convertor and addition reading in which an image-capturing signal obtained by adding the photoelectric conversion signals from the first and second photoelectric convertors is read out.

In the image sensor 122 of this embodiment, a plurality of photoelectric convertors are provided for one microlens arranged in each pixel, and a plurality of light fluxes enter each photoelectric convertor by pupil division. However, the pupil division may be performed by providing one photoelectric convertor for one microlens and shielding a part of the horizontal direction or a part of the vertical direction by a light-shielding layer. Further, the A image signal and the B image signal may be acquired from a pair of focus detection pixels, the pair of focus detection pixels being discretely arranged in an array of a plurality of image-capturing pixels each having only one photoelectric convertor.

The phase difference focus detector 129 performs the focus detection using the input A image signal and B image signal. FIG. 4A shows intensity distributions of the A and B image signals in the in-focus state shown in FIG. 3A. In FIG. 4A, the horizontal axis indicates a pixel position, and the vertical axis indicates a signal intensity. In the in-focus state, the A and B image signals coincide with each other.

FIG. 4B shows intensity distributions of the A and B image signals in the out-of-focus state shown in FIG. 3B. In the out-of-focus state, the A image signal and the B image signal have a phase difference due to the above-described reason, and the peak positions of the intensity are shifted by the image shift amount (phase difference) X. The phase difference focus detector 129 calculates the image shift amount X by performing a correlation operation on the A image signal and the B image signal for each frame, and calculates a focus shift amount from the calculated shift amount X, that is, calculates the defocus amount indicated by Y in FIG. 3B. The phase difference focus detector 129 outputs the calculated defocus amount Y to the camera MPU 125.

The camera MPU 125 calculates a drive amount of the focus lens 104 (hereinafter referred to as a focus drive amount) from the defocus amount Y, and transmits the focus drive amount to the lens MPU 117. The lens MPU 117 causes the focus drive circuit 116 to drive the focus actuator 113 according to the received focus drive amount. Thereby, the focus lens 104 moves to an in-focus position where the in-focus state can be obtained.

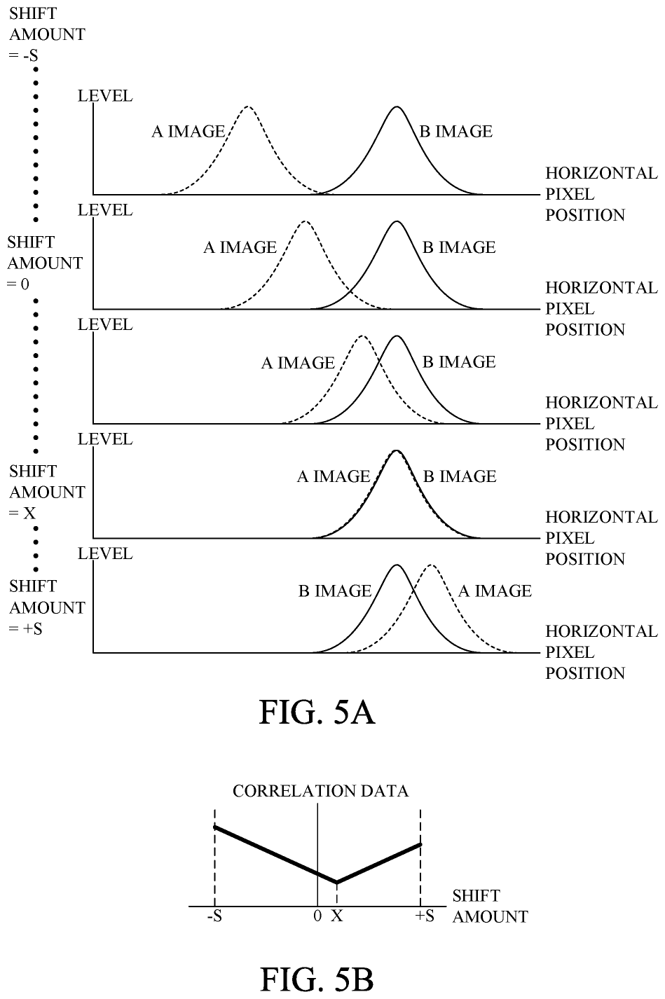

Next, the correlation calculation will be described using FIGS. 5A and 5B. FIG. 5A shows levels (intensity) of the A and B image signals with respect to positions of pixels in the horizontal direction (horizontal pixel position). FIG. 5A shows an example in which the position of the A image signal is shifted with respect to the B image signal in a shift amount range of −S to +S. Here, a state in which the A image signal is shifted to the left with respect to the B image signal is represented by a negative shift amount, and a state in which the A image signal is shifted to the right is represented by a positive shift amount.

In the correlation calculation, an absolute value of a difference between the A and B image signals is calculated for each pixel position, and a value obtained by adding the absolute values for each pixel position is calculated as a correlation value (signal coincidence) for one pixel row. The correlation value calculated in each pixel row may be added to each shift amount over a plurality of rows.

FIG. 5B is a graph showing correlation values (correlation data) calculated for each shift amount in the example shown in FIG. 5A. In FIG. 5B, the horizontal axis indicates the shift amount, and the vertical axis indicates the correlation data. In the example of FIG. 5A, the A image signal and the B image signal overlap each other (coincident) with shift amount=X. In this case, as shown in FIG. 5B, the correlation value becomes minimum at shift amount=X.

The above-described method of calculating the correlation value between the A image signal and the B image signal is merely an example, and another calculation method may be used.

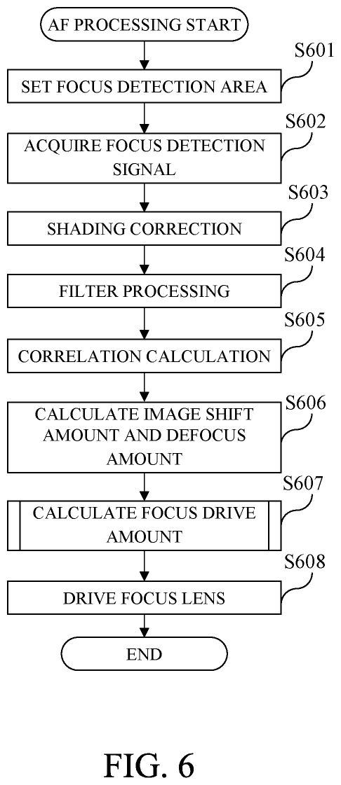

Focus control (AF) processing according to this embodiment will be described with reference to the flowchart of FIG. 6. The camera MPU 125 and the phase difference focus detector 129, which are computers, respectively, execute this processing according to a computer program.

In step S601, the camera MPU 125 sets a focus detection area from the image-capturing surface (effective pixel area) of the image sensor 122.

Next, in step S602, the phase difference focus detector 129 acquires the A image signal and the B image signal as focus detection signals from a plurality of focus detection pixels included in the focus detection area.

Next, in step S603, the phase difference focus detector 129 performs shading correction processing as optical correction processing on each of the A image signal and the B image signal. In the phase difference detection method in which focus detection is performed based on s correlation between the A image signal and the B image signal, a shading of the A image signal and the B image signal may affect the correlation, and an accuracy of the focus detection may be degraded. Therefore, the shading correction processing is performed to prevent this.

Subsequently, in step S604, the phase difference focus detector 129 performs filter processing on each of the A image signal and the B image signal. In general, in the phase difference detection method, focus detection is performed in a large defocus state and thus a pass band of the filter processing is configured to include a low frequency band. However, in order to perform the focus detection from the large defocus state to a small defocus state, the pass band of the filter processing may be adjusted to a high frequency band side according to a defocus state.

Next, in step S605, the phase difference focus detector 129 calculates the correlation value by performing the above-described correlation calculation on the filtered A image signal and B image signal.

Next, in step S606, the phase difference focus detector 129 calculates the defocus amount from the correlation value calculated in step S605. Specifically, the phase difference focus detector 129 calculates the image shift amount X from the shift amount at which the correlation value becomes the minimum value, and calculates the defocus amount by multiplying the image shift amount X by focus sensitivity according to an image height of the focus detection area, an F-number of the diaphragm 102, an exit pupil distance of the lens unit 100.

Next, in step S607, the camera MPU 125 calculates the focus drive amount from the defocus amount calculated by the phase difference focus detector 129. The process of calculating the focus drive amount will be described later.

Subsequently, in step S608, the camera MPU 125 transmits the calculated focus drive amount to the lens MPU 117 to drive the focus lens 104 to the in-focus position. Thereby, the focus control processing ends.

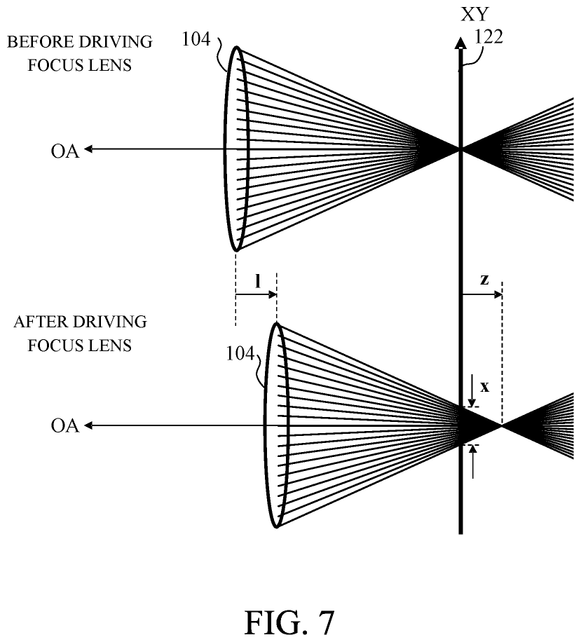

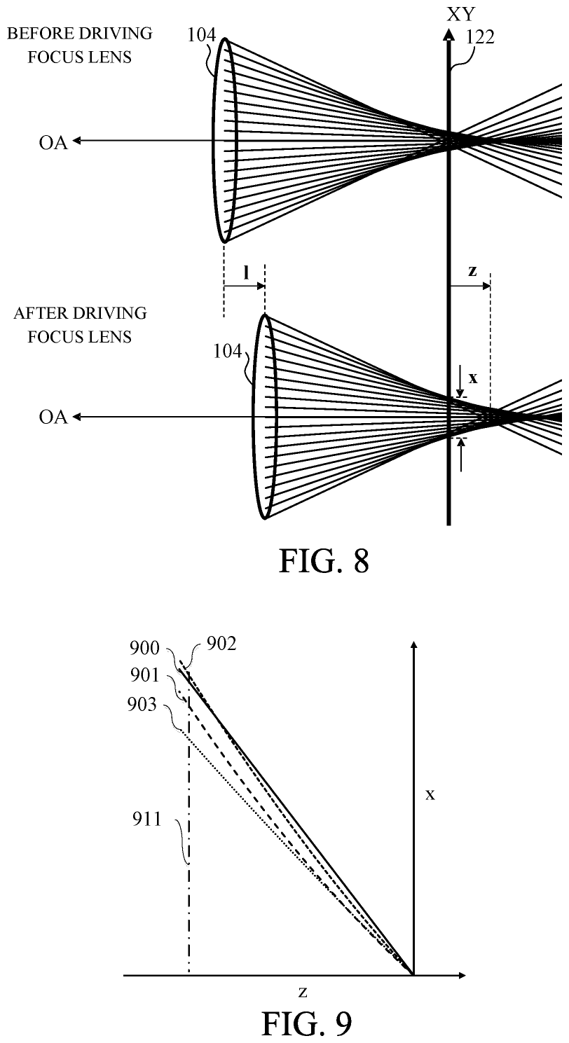

Next, the focus sensitivity and the blur-spread amount used when calculating the focus drive amount from the defocus amount will be described using FIGS. 7 and 8. FIG. 7 shows the focus sensitivity and the blur-spread amount in a state where there is no aberration in the image-capturing optical system. FIG. 8 shows the focus sensitivity and the blur-spread amount in a state where there is aberration in the image-capturing optical system. In each drawing, the upper side shows a light ray group before driving of the focus lens 104, and the lower side shows a light ray group after driving of the focus lens 104. The focus drive amount is indicated by l, and an imaging position is indicated by z. The blur-spread amount is indicated by x. The horizontal axis indicates the optical axis direction OA, the vertical axis indicates an in-plane direction of the image-capturing surface of the image sensor 122, and the origin is an imaging position before the driving of the focus lens 104.

First, the focus sensitivity will be described. In general, the focus sensitivity S used to calculate the focus drive amount from the defocus amount is a ratio of the focus drive amount l to a change amount Δz of the imaging position z, and is expressed by equation (1).

S=Δz/l (1)

This focus sensitivity S is used when calculating the focus drive amount l in step S608 from the defocus amount def calculated in step S606. The focus drive amount l is expressed by equation (2).

L=def/S (2)

On the other hand, in the image-capturing surface phase difference AF, the defocus amount is calculated by detecting the blur-spread amount x of a point image intensity distribution. The blur-spread amount x of the point image intensity distribution is a spread amount of the blurred image in the in-plane direction of the image-capturing surface (hereinafter referred to as an image-capturing in-plane direction), and is different from the imaging position in the optical axis direction OA. Thus, it is necessary to correct the focus sensitivity S from the optical axis direction OA to the image-capturing in-plane direction.

In a state without aberration shown in FIG. 7, since a width of the light ray group changes linearly, a relationship between the imaging position z and the blur-spread amount x also becomes linear. For this reason, if the focus sensitivity S is multiplied by a certain correction data, the focus sensitivity S can be corrected from the optical axis direction OA to the image-capturing in-plane direction. On the other hand, in a state with aberration shown in FIG. 8, since a width of the light ray group changes nonlinearly, a relationship between the imaging position z and the blur-spread amount x is also nonlinear. Therefore, a correction data for correcting the focus sensitivity S from the optical axis direction OA to the image-capturing in-plane direction is a function of the blur-spread amount x. The correction data is data unique to each of a plurality of image-capturing optical systems (lens unit) having different aberrations.

The correction data will be described with reference to FIGS. 9 to 12. FIG. 9 shows a relationship between the imaging position z (horizontal axis) and the blur-spread amount x (vertical axis). The origin is the imaging position before driving of the focus lens 104 and the blur-spread amount before driving of the focus lens 104, and the imaging position at this time is the same position as the image sensor (image-capturing surface) 122. The horizontal axis extends in the optical axis direction OA.

The solid line 900 shows the blur-spread amount x according to the imaging position z in the state without aberration, and the long broken line 901, the short broken line 902 and the dotted line 903, respectively, show the blur-spread amount x according to the imaging position z of the respective lens units having different aberrations due to individual differences.

Looking at the relationship between the imaging position z and the blur-spread amount x shown in FIG. 9, the blur-spread amount x increases as the imaging position z moves away from the origin. This is because the width of the light ray group is expanded as the focus lens 104 is moved and the imaging position z moves away from the image sensor 122 (origin). Further, the solid line 900 indicating the relationship between the imaging position z and the blur-spread amount x in the state without aberration indicates a linear relationship as described in FIG. 7. On the other hand, the broken lines 901 and 902 and the dotted line 903 indicating the relationship between the imaging position z and the blur-spread amount x in the state with aberration indicate a non-linear relationship as described in FIG. 8. Since the respective aberrations are different, their inclinations and non-linearity are different from each other.

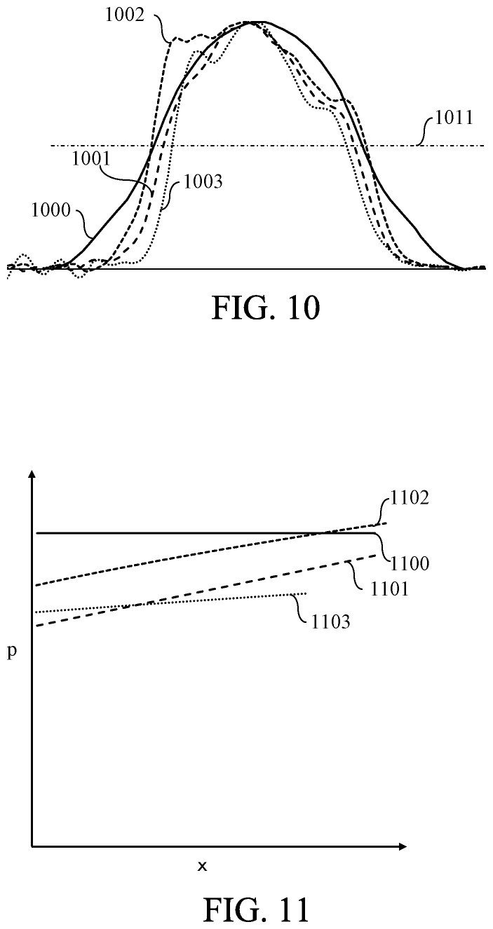

FIG. 10 shows a point image intensity distribution of the image-capturing signal (addition signal of the A image signal and the B image signal) in a defocus state. The horizontal axis indicates a pixel position, and the vertical axis indicates a signal intensity. The solid line 1000, the long broken line 1001, the short broken line 1002 and the dotted line 1003 indicate, respectively, line image intensity distributions (projection of the intensity distribution) which give the blur-spread amount x indicated by the solid line 900, the long broken line 901, the short broken line 902 and the dotted line 903 at the imaging position 911 shown in FIG. 9. For comparison, their peak values are normalized. Further, a dot-and-dash line 1011 indicates a half value of each line image intensity.

The blur-spread amount x at the imaging position 911 in FIG. 9 has the following relation: x on the short broken line 902>x on the solid line 900>x on the long broken line 901>x on the dotted line 903. The width at the half value of each line image intensity (half width) has also the following relation: the half width of the short broken line 1002>the half width of the solid line 1000>the half width of the long broken line 1001>the half width of the dotted line 1003. From this, it can be said that the blur-spread amount x corresponds to the half width of the line image intensity distribution. Therefore, it is possible to calculate the correction data according to the blur-spread amount x from the relationship between the imaging position z and the half width of the line image intensity distribution.

FIG. 11 shows a relationship between the imaging position and the correction data. The horizontal axis indicates the blur-spread amount x, and the vertical axis indicates the correction data P. The solid line 1100, the long broken line 1101, the short broken line 1102 and the dotted line 1103, respectively, indicate the correction data P with respect to the blur-spread amount x indicated by the solid line 900, the long broken line 901, the short broken line 902 and the dotted line 903 in FIG. 9. The correction data P is calculated by equation (3) using the half width of the line image intensity distribution described with reference to FIG. 10 as the blur-spread amount x.

P=x/z (3)

In this embodiment, the correction data P is expressed as a function of the blur-spread amount x. At this time, coefficients (information for acquiring the correction data, hereinafter referred to as correction data calculation coefficient) of a function obtained by approximating the correction data P for each blur-spread amount x with a polynomial are stored in an internal memory (EEPROM 125c) of the camera MPU 125 or an external memory (not shown). The camera MPU 125 calculates the correction data P by substituting the blur-spread amount x into the function using the correction data calculation coefficient. The correction data P may be stored in the EEPROM 125c or the external memory for each blur-spread amount x, and the correction data P corresponding to the blur-spread amount x closest to the detected blur-spread amount may be used. Further, the correction data P to be used may be calculated by interpolation calculation using a plurality of correction data P respectively corresponding to a plurality of blur-spread amounts x close to the detected blur-spread amount.

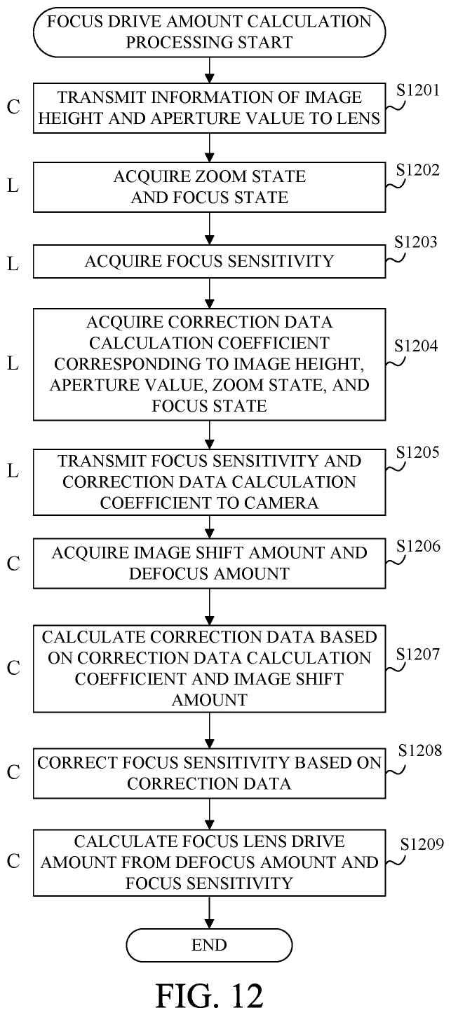

The flowchart in FIG. 12 illustrates focus drive amount calculation processing performed by the camera MPU 125 and the lens MPU 117 in step S607. The camera MPU 125 and the lens MPU 117, which are computers, respectively, execute this processing according to a computer program. In the flowchart of FIG. 12, C indicates processing performed by the camera MPU 125, and L indicates processing performed by the lens MPU 117. The same applies to the flowcharts described in the other embodiments described later.

In step S1201, the camera MPU 125 transmits, to the lens MPU 117, information of the image height of the focus detection area set in step S601 of FIG. 6 and information of the F-number.

Next, in step S1202, the lens MPU 117 acquires a current zoom state (zoom state) and focus state (focus state) of the image-capturing optical system.

Then, in step S1203, the lens MPU 117 acquires, from the lens memory 118, the image height of the focus detection area received in step S1201, and the focus sensitivity S corresponding to the zoom state and focus state acquired in step S1202. The focus sensitivity S may be calculated (acquired) by storing a function of the focus sensitivity S with the image height as a variable in the lens memory 118, substituting the image height acquired in step S1201 into the function.

Next, in step S1204, the lens MPU 117 acquires, from the lens memory 118, the correction data calculation coefficients corresponding to the image height and F-number acquired in step S1201 and the zoom state and focus state acquired in step S1202. The correction data calculation coefficients are coefficients of the function when the correction data P (FIG. 11) calculated using equation (3) is approximated by a second-order polynomial as a function of the blur-spread amount x.

In this embodiment, the correction data calculation coefficients obtained by approximation with the second-order equation are used, but coefficients obtained by approximation with a first-order equation or a third- or higher-order equation may be used as the correction data calculation coefficient.

Further, in this embodiment, the correction data calculation coefficients calculated from the correction data (1101 to 1103) shown in FIG. 11 are used for each lens unit. However, correction data as a design value may be used for each type of lens unit without considering individual differences among lens units. The correction data in this case is also data unique to (type of) the image-capturing optical system.

Subsequently, in step S1205, the lens MPU 117 transmits the focus sensitivity S obtained in step S1203 and the correction data calculation coefficients obtained in step S1204 to the camera MPU 125.

Next, in step S1206, the camera MPU 125 acquires the image shift amount X and the defocus amount def calculated in step S606 of FIG. 6.

Next, in step S1207, the camera MPU 125 calculates (acquires) the correction data P using the correction data calculation coefficients acquired in step S1205 and the image shift amount X acquired in step S1206.

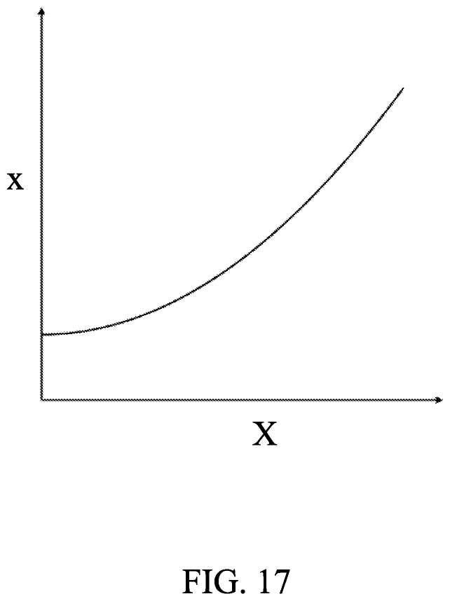

FIG. 17 shows a relationship between the image shift amount X and the blur spread-amount x. The horizontal axis indicates the image shift amount X, and the vertical axis indicates the blur-spread amount x. The relationship shown in FIG. 17 is calculated in advance, and a blur-spread amount conversion coefficient with the image shift amount X as a variable is calculated from FIG. 17 and stored in the EEPROM 125c or the external memory.

The correction data P is calculated by substituting the blur-spread amount x calculated using the image shift amount X acquired in step S606 and the blur-spread amount conversion coefficient into a function represented by the following equation (4).

In equation (4), a, b and c are respectively the second, first and zero-order coefficients of the correction data calculation coefficients.

P=a*x²+b*x+c (4)

In this embodiment, the correction data calculation coefficients with only the blur-spread amount x as a variable are stored, and the correction data is calculated using equation (4). However, the correction data calculation coefficients with both the blur-spread amount x and the image height as variables may be stored, and the correction data may be calculated using a function with these two as variables.

Further, in this embodiment, the correction data P is calculated by converting the blur-spread amount x from the image shift amount X, but the correction data calculation coefficients in which the blur-spread amount conversion coefficient is considered in advance may be stored and the correction data P may be calculated using equation (4) with the image shift amount X as the blur-spread amount x.

Subsequently, in step S1208, the camera MPU 125 corrects the focus sensitivity S acquired in step S1203 using the correction data acquired in step S1207. The corrected focus sensitivity S′ is obtained by the following equation (5).

S′=S*P (5)

Next, in step S1209, the camera MPU 125 calculates the focus drive amount l according to the following equation (6) using the defocus amount def acquired in step S1206 and the focus sensitivity S′ corrected in step S1208.

l=def/S′ (6)

Then, the camera MPU 125 and the lens MPU 117 end this processing.

In this embodiment, the focus sensitivity S and the correction data calculation coefficients are transmitted from the lens MPU 117 to the camera MPU 125, and the camera MPU 125 calculates the correction data using these. However, the camera MPU 125 may transmit the image shift amount (phase difference) X to the lens MPU 117 in step S1206, and the lens MPU 117 may calculate the correction data in step S1207. In this case, the lens MPU 117 transmits the calculated correction data to the camera MPU 125.

According to this embodiment, the focus sensitivity is corrected using the correction data corresponding to the blur-spread amount. As a result, the focus drive amount can be calculated using the focus sensitivity appropriate for each of the plurality of image-capturing optical systems having different aberrations, and the image-capturing surface phase difference AF can be performed with high accuracy.

### Second Embodiment

Next, the second embodiment of the present invention will be described. This embodiment differs from the first embodiment in the focus drive amount calculation processing. The configuration of the camera system 10 of this embodiment and processing other than the focuser drive amount calculation processing are the same as in the first embodiment.

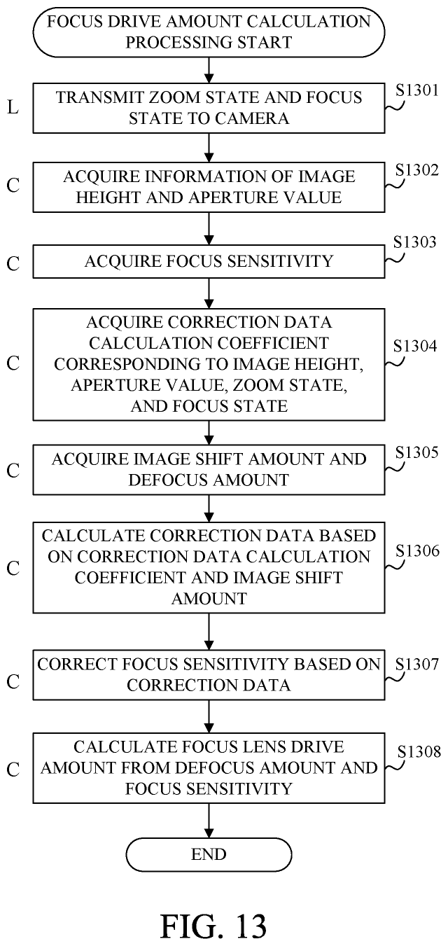

The flowchart of FIG. 13 shows the focus drive amount calculation processing performed by the camera MPU 125 and the lens MPU 117 in step S607 of FIG. 6 described in the first embodiment in this embodiment.

First, in step S1301, the lens MPU 117 transmits the current zoom state and focus state of the image-capturing optical system to the camera MPU 125.

Next, in step S1302, the camera MPU 125 acquires information of the image height of the focus detection area and the F-number of the diaphragm 102.

Next, in step S1303, the camera MPU 125 acquires, from the EEPROM 125c, the focus sensitivity S corresponding to the zoom state and focus state acquired in step S1301 and the image height acquired in step S1302. The focus sensitivity S may be calculated (acquired) by storing a function of the focus sensitivity S with the image height as a variable in the EEPROM 125c and substituting the image height acquired in step S1302 into the function.

Subsequently, in step S1304, the camera MPU 125 acquires, from the EEPROM 125c, the correction data calculation coefficients corresponding to the zoom state and focus state acquired in step S1301 and the image height and F-number acquired in step S1302. The correction data calculation coefficients are coefficients of the function when the correction data P (FIG. 11) calculated using equation (3) is approximated by a second-order polynomial as a function of the blur-spread amount x.

In this embodiment, the correction data calculation coefficients obtained by approximation with the second-order equation are used, but coefficients obtained by approximation with a first-order equation or a third- or higher-order equation may be used as the correction data calculation coefficient.

Next, in step S1305, the camera MPU 125 acquires the image shift amount X and the defocus amount def calculated in step S606 of FIG. 6.

Next, in step S1306, the camera MPU 125 calculates (acquires) the correction data P by substituting the correction data calculation coefficients obtained in step S1304 and the blur-spread amount x calculated from the image shift amount X obtained in step S1305 into equation (4).

Subsequently, in step S1307, the camera MPU 125 corrects the focus sensitivity S acquired in step S1303 according to equation (5), using the correction data P acquired in step S1306.

Next, in step S1308, the camera MPU 125 calculates the focus drive amount l according to equation (6) using the defocus amount def acquired in step S1305 and the focus sensitivity S′ corrected in step S1307. Then, the camera MPU 125 and the lens MPU 117 end this processing.

Also in this embodiment, as in the first embodiment, the focus sensitivity is corrected using the correction data corresponding to the blur-spread amount. As a result, the focus drive amount can be calculated using the focus sensitivity appropriate for each of the plurality of image-capturing optical systems having different aberrations, and the image-capturing surface phase difference AF can be performed with high accuracy.

### Third Embodiment

Next, the third embodiment of the present invention will be described. This embodiment is different from the first embodiment in the correction data calculation processing and the focus drive amount calculation processing. The configuration of the camera system 10 of this embodiment and the processing other than the focus drive amount calculation processing are the same as in the first embodiment.

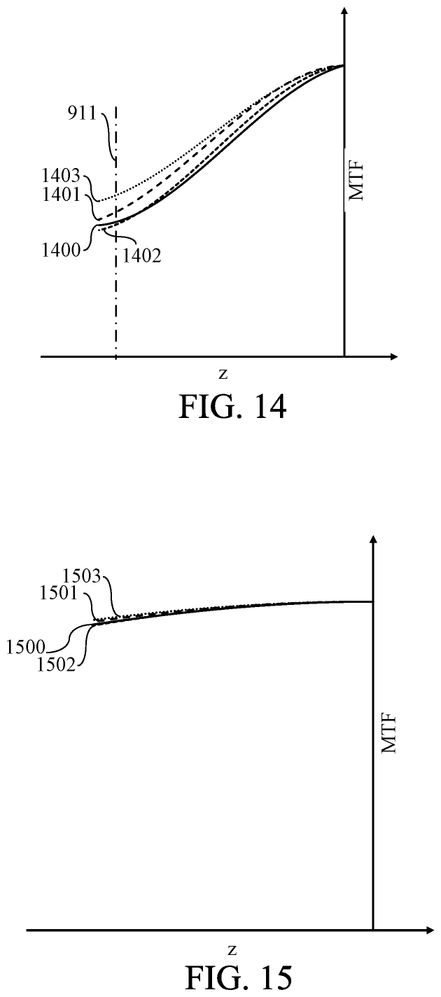

The correction data in this embodiment will be described with reference to FIGS. 14 and 15. FIGS. 14 and 15 show a relationship between the imaging position and the MTF (8 lines/mm) and a relationship between the imaging position and the MTF (2 lines/mm), respectively. In these figures, the horizontal axis indicates the imaging position z, and the vertical axis indicates the MTF. The MTF is an absolute value of an optical transfer function obtained by Fourier-transforming a point image intensity distribution.

In FIG. 14, the solid line 1400, the long broken line 1401, the short broken line 1402 and the dotted line 1403, respectively, indicate the MTFs of frequency 8 lines/mm calculated from the point image intensity distributions shown by the solid line 1000, the long broken line 1001, the short broken line 1002 and the dotted line 1003 in FIG. 10. In FIG. 15, the solid line 1500, the long broken line 1501, the short broken line 1502 and the dotted line 1503, respectively, indicate the MTFs of frequency 2 lines/mm calculated from the point image intensity distributions shown by the solid line 1000, the long broken line 1001, the short broken line 1002 and the dotted line 1003 in FIG. 10.

The MTF of each frequency corresponds to the blur-spread amount x at each frequency. In the MTFs 1400 to 1403 of 8 lines/mm shown in FIG. 14, differences among them at the imaging position 911 are large. On the other hand, in the MTFs 1500 to 1503 of 2 lines/mm shown in FIG. 15, differences among them at the imaging position 911 are small. The MTF corresponding to the blur-spread amount x is different for each frequency, and it is necessary to correct the focus sensitivity by the correction data of the frequency adjusted to a frequency band of focus detection. For this reason, in this embodiment, instead of the half width of the line image intensity distribution of the first embodiment, the correction data calculated from the relationship between the imaging position and the MTF is stored in the lens memory 118. Thereby, the correction data can be corrected according to the frequency band of focus detection.

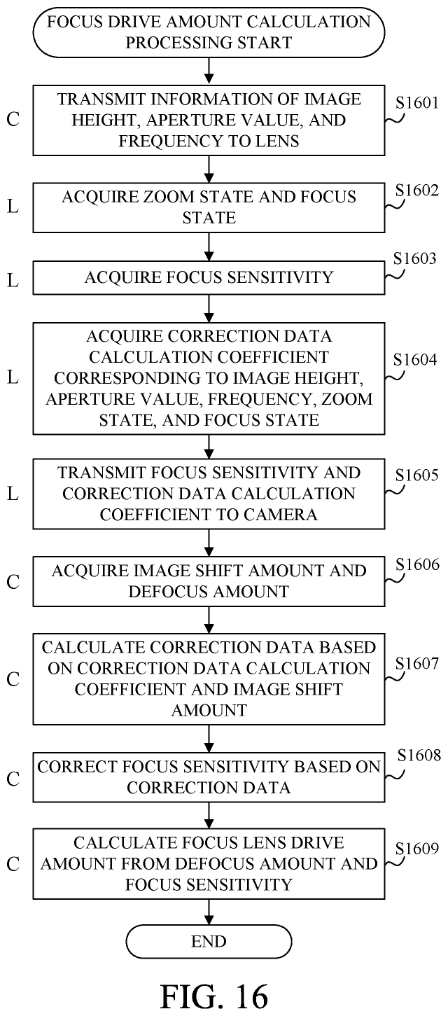

The flowchart in FIG. 16 shows the focus drive amount calculation processing performed by the camera MPU 125 and the lens MPU 117 in step S607 of FIG. 6 described in the first embodiment in this embodiment.

First, in step S1601, the camera MPU 125 transmits, to the lens MPU 117, information of the image height of the focus detection area set in step S601, information of the F-number, and information of frequency of the focus detection. The frequency of the focus detection is a frequency band of a signal used for the focus detection, and is determined by a filter or the like used in the filter processing of step S604 in FIG. 6.

Next, in step S1602, the lens MPU 117 acquires the current zoom state and focus state of the image-capturing optical system.

Next, in step S1603, the lens MPU 117 acquires the focus sensitivity S from the lens memory 118 using the image height acquired in step S1601 and the zoom state and focus state acquired in step S1602. A function of the focus sensitivity S with the image height as a variable may be stored in the lens memory 118, and the focus sensitivity S may be calculated (acquired) by substituting the image height acquired in step S1601 into the function.

Subsequently, in step S1604, the lens MPU 117 acquires, from the lens memory 118, the correction data calculation coefficients corresponding to the image height, F-number, and frequency acquired in step S1601, and the zoom state and focus state acquired in step S1602. The correction data calculation coefficients are coefficients of the function when the correction data P (FIG. 11) calculated using equation (3) is approximated by a second-order polynomial as a function of the blur-spread amount x.

In this embodiment, the correction data calculation coefficients obtained by approximation with the second-order equation are used, but coefficients obtained by approximation with a first-order equation or a third- or higher-order equation may be used as the correction data calculation coefficient.

Further, as to the frequency, the correction data calculation coefficients corresponding to a band spanned by the frequency band of the focus detection may be acquired, or the correction data calculation coefficients may be acquired by calculation with weighting according to a frequency response.

Further, in this embodiment, the correction data calculation coefficients calculated from the correction data (1101 to 1103) shown in FIG. 11 are used for each lens unit. However, correction data as a design value may be used for each type of lens unit without considering individual differences among lens units.

Next, in step S1605, the lens MPU 117 transmits the focus sensitivity acquired in step S1603 and the correction data calculation coefficients acquired in step S1604 to the camera MPU 125.

Next, in step S1606, the camera MPU 125 acquires the image shift amount X and the defocus amount def calculated in step S606 of FIG. 6.

Subsequently, in step S1607, the camera MPU 125 calculates (acquires) the correction data P by substituting the correction data calculation coefficients acquired in step S1604 and the blur-spread amount x calculated from the image shift amount X acquired in step S1606 into equation (4).

In this embodiment, the correction data calculation coefficients with only the blur-spread amount x as a variable are stored, and the correction data is calculated using equation (4). However, the correction data calculation coefficients having three variables of the blur-spread amount x, image height and frequency may be stored, and the correction data may be calculated using a function having these three as variables.

Subsequently, in step S1608, the camera MPU 125 corrects, according to equation (5), the focus sensitivity S acquired in step S1603 by using the correction data P calculated in step S1607.

Next, in step S1609, the camera MPU 125 calculates the focus drive amount l by equation (6) using the defocus amount def acquired in step S1606 and the focus sensitivity S′ corrected in step S1608. Then, the camera MPU 125 and the lens MPU 117 end this processing.

In this embodiment, the focus sensitivity S and the correction data calculation coefficients are transmitted from the lens MPU 117 to the camera MPU 125, and the camera MPU 125 calculates the correction data using these. However, the camera MPU 125 may transmit the image shift amount X to the lens MPU 117 in step S1606, and the lens MPU 117 may calculate the correction data in step S1607. In this case, the lens MPU 117 transmits the calculated correction data to the camera MPU 125.

Further, although the case of storing the focus sensitivity and the correction data in the lens memory 118 has been described in this embodiment, these may be stored in the EEPROM 125c.

In this embodiment, the focus sensitivity is corrected using the correction data corresponding to the blur-spread amount in the frequency band of the focus detection. As a result, the focus drive amount can be calculated using the focus sensitivity appropriate for each of the plurality of image-capturing optical systems having different aberrations in any frequency band of the focus detection, and the image-capturing surface phase difference AF can be performed with high accuracy.

Although the case of moving the focus lens 104 in focus control has been described in each of the above embodiments, the image sensor 122 may be moved as a focus element.

According to each of the above embodiments, high-accuracy focus control can be performed on each of the plurality of image-capturing optical systems having different aberrations.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-172935, filed on Sep. 14, 2018 which is hereby incorporated by reference herein in its entirety.

What is claimed is:

1. An optical apparatus as an image-capturing apparatus to which an image-capturing optical system is interchangeably attached, the optical apparatus comprising:
an image sensor configured to capture an object image formed via the image-capturing optical system;
a focus detector configured to perform focus detection by a phase difference detection method using the image sensor; and
a controller having a processor which executes instructions stored in a memory or having circuitry, the controller being configured to calculate a drive amount of a focus element using a defocus amount acquired by the focus detection and a focus sensitivity of the image-capturing optical system,
wherein the controller
acquires correction data unique to the attached image-capturing optical system and corresponding to a blue spread amount on the image sensor, and
calculates the drive amount using the focus sensitivity corrected by using the correction data.

2. The optical apparatus according to claim 1,
wherein the controller
receives information for acquiring the correction data from an interchangeable lens apparatus having the image-capturing optical system, and
acquires the correction data using the information.

3. An optical apparatus as an interchangeable lens apparatus which is interchangeably attached to an image-capturing apparatus which performs focus detection by a phase difference detection method using an image sensor configured to capture an object image formed by an image-capturing optical system, the optical apparatus comprising:
the image-capturing optical system; and
a controller having a processor which executes instructions stored in a memory or having circuitry, the controller being configured to transmit, to the image-capturing apparatus, information for causing the image-capturing apparatus to acquire correction data unique to the image-capturing optical system for correcting a focus sensitivity of the image-capturing optical system and corresponding to a blur-spread amount on the image sensor.

4. The optical apparatus according to claim 2, wherein the information is a coefficient of a function used for calculating the correction data.

5. An optical apparatus as an interchangeable lens apparatus which is interchangeably attached to an image-capturing apparatus which performs focus detection by a phase difference detection method using an image sensor configured to capture an object image formed via an image-capturing optical system, the image-capturing apparatus configured to calculate a drive amount of a focus element using a defocus amount acquired by the focus detection and a focus sensitivity of the image-capturing optical system, the optical apparatus comprising:
the image-capturing optical system; and
a controller having a processor which executes instructions stored in a memory or having circuitry, the controller being configured to acquire correction data unique to the image-capturing optical system for correcting the focus sensitivity and corresponding to a blur-spread amount on the image sensor, and transmit the correction data to the image-capturing apparatus.

6. The optical apparatus according to claim 1, wherein the controller calculates the blur-spread amount from a phase difference detected by the focus detection.

7. The optical apparatus according to claim 1, wherein the correction data is data corresponding to an aberration of the image-capturing optical system.

8. The optical apparatus according to claim 1, wherein the correction data is data corresponding to a frequency with which the focus detection is performed.

9. The optical apparatus according to claim 1, wherein the correction data is data corresponding to an aperture value of the image-capturing optical system.

10. The optical apparatus according to claim 1, wherein the correction data is data corresponding to an image height with which the focus detection is performed.

11. The optical apparatus according to claim 1, wherein the correction data is data corresponding to a zoom state and focus state of the image-capturing optical system.

12. A control method for an optical apparatus as an image-capturing apparatus to which an image-capturing optical system is interchangeably attached and which has an image sensor configured to capture an object image formed via the image-capturing optical system, the control method comprising:
a step of performing focus detection by a phase difference detection method using the image sensor; and
a step of calculating a drive amount of a focus element using a defocus amount acquired by the focus detection and a focus sensitivity of the image-capturing optical system,
wherein the step of calculating the drive amount
acquires correction data unique to the attached image-capturing optical system and corresponding to a blur-spread amount on the image sensor, and
calculates the drive amount using the focus sensitivity corrected by using the correction data.

13. A control method for an optical apparatus as an interchangeable lens apparatus which is interchangeably attached to an image-capturing apparatus which performs focus control by a phase difference detection method using an image sensor configured to capture an object image formed via an image-capturing optical system, the control method comprising:
a step of transmitting, to the image-capturing apparatus, information for causing the image-capturing apparatus to acquire correction data unique to the image-capturing optical system for correcting a focus sensitivity of the image-capturing optical system and corresponding to a blur-spread amount on the image sensor.

14. A control method for an optical apparatus as an interchangeable lens apparatus which is interchangeably attached to an image-capturing apparatus which performs focus control by a phase difference detection method using an image sensor configured to capture an object image formed via an image-capturing optical system, the image-capturing apparatus configured to calculate a drive amount of a focus element using a defocus amount acquired by the focus detection and a focus sensitivity of the image-capturing optical system, the control method comprising:
a step of acquiring correction data unique to the image-capturing optical system for correcting the focus sensitivity and corresponding to a blur-spread amount on the image sensor; and
a step of transmitting the correction data to the image-capturing apparatus.

15. A non-transitory computer-readable storage medium for storing a computer program that enables a computer to execute a control method for an optical apparatus as an image-capturing apparatus to which an image-capturing optical system is interchangeably attached and which has an image sensor configured to capture an object image formed via the image-capturing optical system, the control method comprising:
a step of performing focus control by a phase difference detection method using the image sensor; and
a step of calculating a drive amount of a focus element using a defocus amount acquired by the focus detection and a focus sensitivity of the image-capturing optical system,
wherein the step of calculating the drive amount
acquires correction data unique to the attached image-capturing optical system and corresponding to a blur-spread amount on the image sensor, and
calculates the drive amount using the focus sensitivity corrected by using the correction data.

16. A non-transitory computer-readable storage medium for storing a computer program that enables a computer to execute a control method for an optical apparatus as an interchangeable lens apparatus which is interchangeably attached to an image-capturing apparatus which performs focus control by a phase difference detection method using an image sensor configured to capture an object image formed via an image-capturing optical system, the control method comprising:
a step of transmitting, to the image-capturing apparatus, information for causing the image-capturing apparatus to acquire correction data unique to the image-capturing optical system for correcting a focus sensitivity of the image-capturing optical system and corresponding to a blur-spread amount on the image sensor.

17. A non-transitory computer-readable storage medium for storing a computer program that enables a computer to execute a control method for an optical apparatus as an interchangeable lens apparatus which is interchangeably attached to an image-capturing apparatus which performs focus control by a phase difference detection method using an image sensor configured to capture an object image formed via an image-capturing optical system, the image-capturing apparatus configured to calculate a drive amount using a defocus amount acquired by the focus detection and a focus sensitivity of the image-capturing optical system, the control method comprising:
a step of acquiring correction data unique to the image-capturing optical system for correcting the focus sensitivity; and
a step of transmitting the correction data to the image-capturing apparatus.
